(19) United States
(12) Patent Application Publication
(10) Pub. No.: US 2018/0150729 A1
(43) Pub. Date: May 31, 2018

(54) DYNAMIC STORAGE OF RASTER DATA AT A RIP SPOOL FOR MULTIPLE COPY PRINT JOBS

(71) Applicants: Katie Ashley Eng, Boulder, CO (US); Stephen Jared Mandry, Longmont, CO (US); Miki Judy Ushijima, Longmont, CO (US); David Ward, Broomfield, CO (US)

(72) Inventors: Katie Ashley Eng, Boulder, CO (US); Stephen Jared Mandry, Longmont, CO (US); Miki Judy Ushijima, Longmont, CO (US); David Ward, Broomfield, CO (US)

(73) Assignee: Ricoh Company, Ltd., Tokyo (JP)

(21) Appl. No.: 15/361,888

(22) Filed: Nov. 28, 2016

(51) Int. Cl. G06K 15/02; G06F 3/12

(52) U.S. Cl. CPC G06K 15/1861; G06K 15/1813; G06K 15/1817; G06F 3/1248; G06K 15/1836; G06K 15/1886; G06F 3/122; G06K 15/1809

(57) ABSTRACT

Embodiments described herein provide for dynamic storage of raster data at a rip spool while printing copies of a multiple copy print job. When printing multiple copies of a print job, some of the print data for the print job is rasterized once, spooled, and de-spooled multiple times for each copy of the print job. The rest of the print data for the print job is rasterized multiple times for each copy of the print job. In the embodiments described herein, additional storage space on the rip spool that becomes available while printing multiple copies of a print job is utilized to store additional raster data for the print job. This reduces the amount of the print data for the print job that is rasterized multiple times.

### FIELD OF THE INVENTION

The invention relates to the field of printing systems, and in particular, to rip spools that store raster data for print jobs.

### BACKGROUND

Printing systems generally include a print controller that receives raw print data (e.g., Page Description Language (PDL) data), and a print engine. The print controller rasterizes the logical pages of the print job into bitmap images. Typically, bitmap images for the print job take up a much larger amount of storage space than the original PDL data for the print job. Thus, some modern printing systems may also include one or more storage devices (e.g., hard disk drives, solid state drives, etc.) to store bitmap data. A storage device (or a partition of a storage device) that is used to store bitmap data may also be referred to as a rip spool.

During the printing process, print data for the print job (e.g., PDL data) is rasterized and stored at the rip spool. The bitmap data may then be de-spooled and sent to a print engine for imprinting to a media, such as paper. The rip spool is used as a buffer between the rasterization process and the imprinting process, because the time required to rasterize different print jobs (or different parts of the same print job) may vary due to differences in the complexity of the PDL data. Therefore, while a print engine may consume bitmap data at a nearly fixed rate based on the print speed of the printing system, the rasterizer (or rasterizers) produces bitmap data at a varying rate based on the complexity of the PDL data in the print job.

When printing multiple copies of a print job, it is more efficient to rasterize the print job once and to store the complete raster data for the print job at the rip spool. Raster data for the print job may then be de-spooled multiple times off of the rip spool and sent to the print engine. This improves the throughput of the printing process because it is faster to de-spool the raster data multiple times from the rip spool than it is to rasterize the print job multiple times.

A rip spool, although large in storage space, is a finite resource and therefore, may eventually run out of storage space (e.g., become full). Also, the rip spool may be too small to store a complete rasterized version of a print job. It thus remains a problem to utilize a rip spool efficiently during the printing process.

### SUMMARY

Embodiments described herein provide for dynamic storage of raster data at a rip spool while printing copies of a multiple copy print job. When printing multiple copies of a print job, some of the print data for the print job is rasterized once, spooled, and de-spooled multiple times, once for each copy of the print job. The rest of the print data for the print job is rasterized multiple times, once for each copy of the print job. In the embodiments described herein, additional storage space on the rip spool that becomes available while printing multiple copies of a job is utilized to store additional raster data for the print job. This reduces the amount of the print data for the print job that is rasterized multiple times.

One embodiment comprises a print controller that receives a command to print multiple copies of a print job, and stores print data for the print job in a buffer for rasterization. In response to printing one copy of the multiple copies of the print job, the print controller rasterizes a first portion of the print data stored in the buffer to generate a first rasterized portion, and stores the first rasterized portion at a rip spool. In response to printing a subsequent copy of the multiple copies of the print job, the print controller sends the first rasterized portion from the rip spool to a print engine, and rasterizes a second portion of the print data stored in the buffer that is not stored at the rip spool to generate a second rasterized portion. The print controller determines if an amount of storage space available at the rip spool is sufficient to store the second rasterized portion, and stores the second rasterized portion at the rip spool in response to determining that the amount of storage space available is sufficient.

Another embodiment comprises a method of dynamically storing raster data at a rip spool during a multiple copy print job. The method comprises receiving a command to print multiple copies of a print job, and storing print data for the print job in a buffer for rasterization. In response to printing one copy of the multiple copies of the print job, the method further comprises rasterizing a first portion of the print data stored in the buffer to generate a first rasterized portion, and storing the first rasterized portion at a rip spool. In response to printing a subsequent copy of the multiple copies of the print job, the method further comprises sending the first rasterized portion from the rip spool to a print engine, rasterizing a second portion of the print data stored in the buffer that is not stored at the rip spool, and determining if an amount of storage space available at the rip spool is sufficient to store the second rasterized portion. The method further comprises storing the second rasterized portion at the rip spool in response to determining that the amount of storage space available is sufficient.

Another embodiment comprises non-transitory computer-readable medium embodying programmed instructions which, when executed by processor of a print controller, direct the processor to receive a command to print multiple copies of a print job, and store print data for the print job in a buffer for rasterization. In response to printing one copy of the multiple copies of the print job, the instructions further direct the processor to rasterize a first portion of the print data stored in the buffer to generate a first rasterized portion, and store the first rasterized portion at a rip spool. In response to printing a subsequent copy of the multiple copies of the print job, the instructions further direct the processor to send the first rasterized portion from the rip spool to a print engine, rasterize a second portion of the print data stored in the buffer that is not stored at the rip spool, and determine if an amount of storage space available at the rip spool is sufficient to store the second rasterized portion. The instructions further direct the processor to store the second rasterized portion at the rip spool responsive to determining that the amount of storage space is sufficient.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of a printing system in an exemplary embodiment.

FIG. 2 is flow chart for a method of dynamically storing raster data at a rip spool during a multiple copy print job in an exemplary embodiment.

FIGS. 3-4 are flow charts for another method of dynamically storing raster data at a rip spool during a multiple copy print job in another exemplary embodiment.

FIG. 5 is a block diagram of another printing system in another exemplary embodiment.

FIG. 6 illustrates a computing system in which a computer readable medium may provide instructions for performing the methods of FIGS. 2-4 in an exemplary embodiment.

### DESCRIPTION OF THE EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

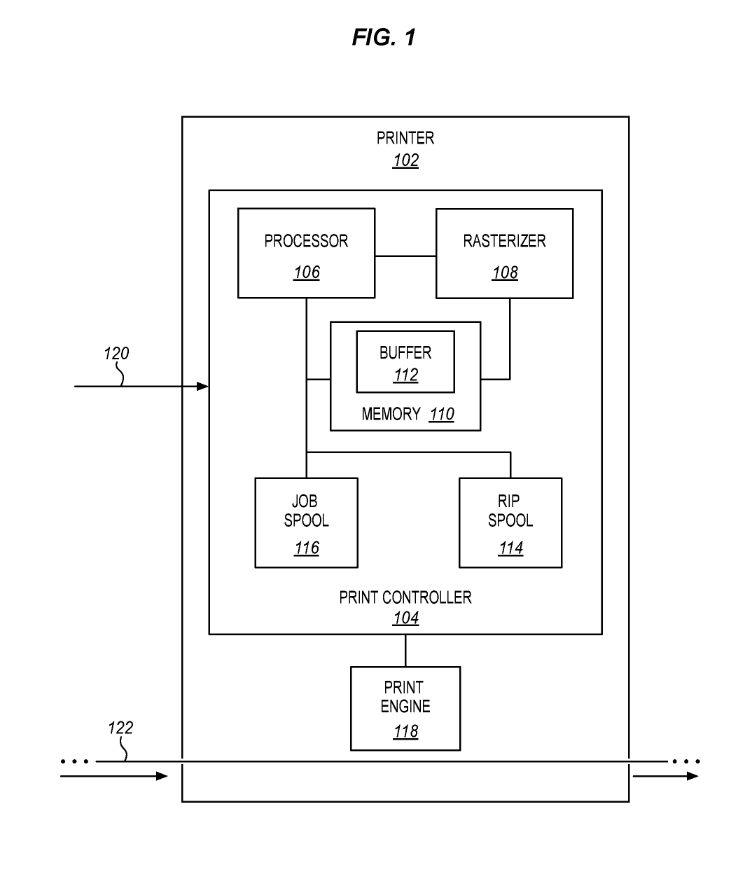

FIG. 1 is a block diagram of a printing system 102 in an exemplary embodiment. FIG. 1 also illustrates a media 122 for imprinting by printing system 102. Media 122 travels in the direction indicated by the arrow in FIG. 1. Media 122 may be cut sheet media or continuous form media that is used by a high-speed production printing system.

In this embodiment, printing system 102 includes a print controller 104 and a print engine 118. In printing system 102, print controller 104 receives print data 120 for imprinting onto media 122, and may spool print data 120 to a job spool 116 until the print job is ready for rasterization. Print controller 104 may also perform a number of data processing operations on print data 120, such as generating raster bitmaps of the logical pages of print data 120 and spooling the bitmap data to a rip spool 114. Print controller 104 may then de-spool the bitmap data from rip spool 114 and provide the bitmap data to print engine 118. Print engine 118 applies a colorant to media 122 based on the bitmap data.

In this embodiment, print controller 104 includes a processor 106 that is able to control the operation of print controller 104, a rasterizer 108 that rasterizes print data 120 to generate raster data, and a memory 110. Memory 110 stores a buffer 112, which temporarily stores print data 120 for rasterizer 108.

While the specific hardware implementation of print controller 104 is subject to design choices, one particular embodiment may include one or more processors 106 communicatively coupled with memory 110. Processor 106 includes any electronic circuits and/or optical circuits that are able to perform functions. For example, processor 106 may perform any functionality described herein for print controller 104. Processor 106 may include one or more Central Processing Units (CPU), microprocessors, Digital Signal Processors (DSPs), Application-specific Integrated Circuits (ASICs), Programmable Logic Devices (PLDs), control circuitry, etc. Some examples of processors include INTEL® CORE™ processors, Advanced Reduced Instruction Set Computing (RISC) Machines (ARM®) processors, etc.

Memory 110 includes any electronic circuits, and/or optical circuits, and/or magnetic circuits that are able to store data. For instance, memory 110 may store buffer 112, may store programmed instructions for processor 106 to implement the functionality described herein for print controller 104, etc. Memory 110 may include one or more volatile or non-volatile Dynamic Random Access Memory (DRAM) devices, FLASH devices, volatile or non-volatile Static RAM devices, magnetic disk drives, Solid State Disks (SSDs), etc. Some examples of non-volatile DRAM and SRAM include battery-backed DRAM and battery-backed SRAM.

When printing multiple copies of a print job, it is generally much faster to rasterize the print job (e.g., a print job received as print data 120) once to rip spool 114 and then de-spool the raster data for the print job multiple times to print engine 118 than it is to rasterize the print job multiple times. However, in some cases rip spool 114 may not have sufficient storage space to store a complete rasterized version of the print job, at least temporarily. For example, the raster data for the print job may be too large to fit on rip spool 114. Also, other jobs may be stored as bitmap images on rip spool 114, thus rendering rip spool 114 unavailable (e.g., full) for storing bitmap data for the print job.

In some printing systems, if a rip spool does not have enough storage space available for storing raster data for a print job that is intended to be printed multiple times, then the print job may be aborted. The following example will clarify how this may occur. As jobs are received by the printing system, the print jobs are written to a job spool (e.g., job spool 116). Each of the print jobs is subsequently de-spooled and buffered in a pipeline for rasterization. During a rasterization process for a multiple copy print job, raster data for the print job is written to a rip spool. If the rip spool becomes full or otherwise is unavailable to store a complete raster version of the print job, then aborting the print job may be the only option as other jobs are already in the pipeline for rasterization subsequent to the current print job. Thus, multiple copies of the print job cannot be printed, as only one copy of the print job is in the pipeline for rasterization. Also, the rip spool does not have the storage space available to store a complete rasterized version of the print job for de-spooling the rasterized version multiple times.

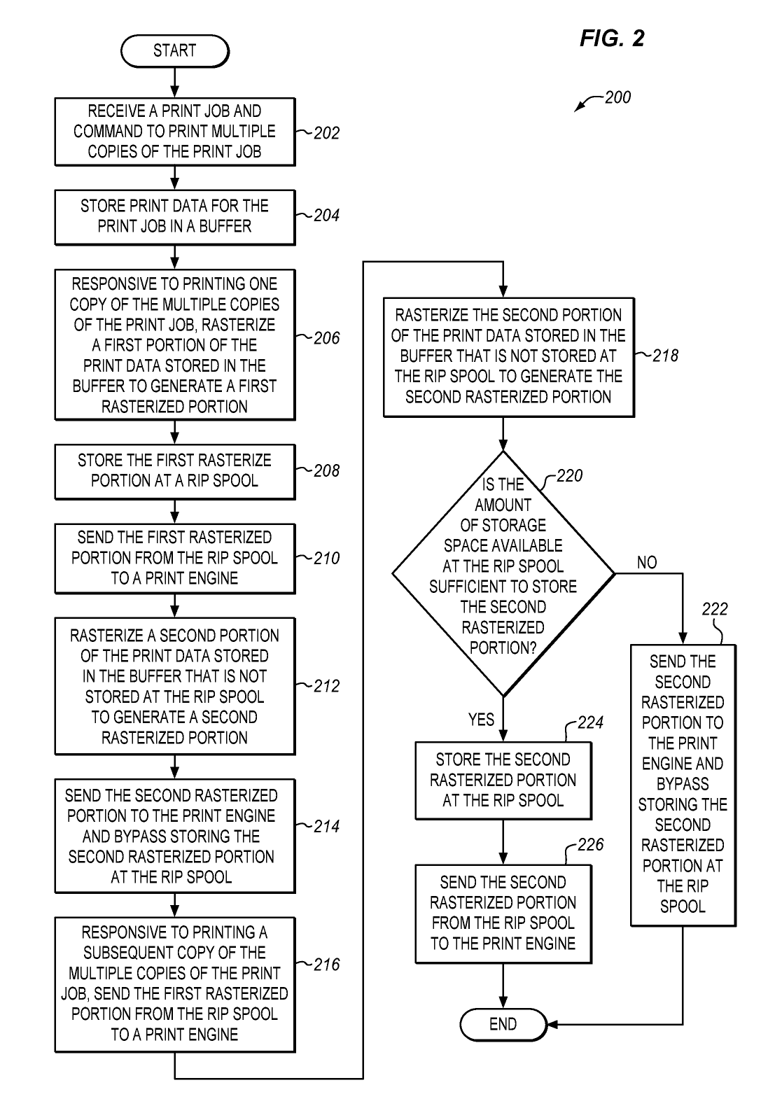

In this embodiment, print controller 104 does not abort a multiple copy job if rip spool 114 is otherwise unavailable for storing a complete rasterized version of the print job. Instead, print controller 104 buffers for rasterizer 108 one copy of print data 120 for the print job, and rasterizes and stores raster data for a portion of the print job at rip spool 114. Print controller 104 then de-spools the raster data at rip spool 114 multiple times to print engine 118 to print each of the multiple copies of the print job. For raster data for the portion of print job that is not stored at rip spool 114, print controller 104 rasterizes the print data 120 for the portion multiple times and provides it to print engine 118, once for each copy of the print job. If during the printing of the multiple copies, the amount of storage that is available at rip spool 114 increases, then additional raster data for the print job is spooled to rip spool 114, which reduces the remaining amount of print data for the print job that is rasterized multiple times. This allows print controller 104 to recover and print a multiple copy print job even though rip spool 114 may be unavailable to store a complete raster image of the print job. Further, this also allows print controller 104 to utilize the additional storage space that becomes available at rip spool 114 while printing the multiple copies of the print job. An example of print controller 104 in operation will be discussed in more detail with regard to FIG. 2.

FIG. 2 is flow chart of a method 200 of dynamically storing raster data at a rip spool during a multiple copy print job in an exemplary embodiment. The steps of method 200 will be described with respect to printing system 102 of FIG. 1, although one skilled in the art will understand that method 200 may be performed by other systems not shown. The steps of the methods described herein are not all inclusive and may include other steps not shown. The steps of the methods described herein may also be performed in an alternative order.

Assume for this embodiment that processor 106 of print controller 104 (see FIG. 1) receives a command to print multiple copies of a print job (step 202 of FIG. 2). The command may be part of a job ticket for the print job. A job ticket defines metadata for a print job, such as the number of copies, the media size, the number of logical pages on a sheet side (e.g., n-up printing configuration), etc. The print job ticket (along with the print job) may be stored on job spool 116.

Processor 106 stores print data 120 for rasterizer 108 in buffer 112 (see step 204). To store a copy of the print job, processor 106 may de-spool the print job once off of job spool 116 and store the copy in buffer 112. To print one copy of the multiple copies of the print job, rasterizer 108 rasterizes a first portion of print data 120 stored in buffer 112 to generate a first rasterized portion (see step 206). Processor 106 stores the first rasterized portion at rip spool 114 (see step 208). Step 208 may be performed if rip spool 14 has space available to store the first rasterized portion. Processor 106 sends the first rasterized portion from rip spool 114 (or from buffer 112, if raster data for the first rasterized portion is still in buffer 112) to print engine 118 to begin printing the one copy (see step 210). Rasterizer 108 then rasterizes print data 120 that is not stored at rip spool 114 “on-the-fly” to generate a second rasterized portion (see step 212). To finish printing the one copy, rasterizer 108 sends the second rasterized portion to print engine 118, bypassing the storage of the second rasterized portion at rip spool 114 (see step 214).

To print a subsequent copy of the multiple copies of the print job, processor 106 sends the first rasterized portion stored on rip spool 114 to print engine 118 (see step 216). Rasterizer 108 rasterizes print data 120 that is not stored at rip spool 114 to generate the second rasterized portion (see step 218). Processor 106 determines if an amount of storage space available at rip spool 114 is sufficient to store the second rasterized portion (see step 220). If the amount of storage space is sufficient, then processor 106 stores the second rasterized portion at rip spool 114 (see step 224), and processor 106 sends the second rasterized portion from rip spool 114 to print engine 118 (see step 226). If the amount of storage space is not sufficient to store the second rasterized portion at rip spool 114, then rasterizer 108 sends the second portion to print engine 118, bypassing the storage of the second rasterized portion at rip spool 114 (see step 222).

In some cases, processor 106 may determine that rip spool 114 has storage space available to store a complete rasterized version of the print job in step 220. For instance, processor 106 may receive a notification from rasterizer 108 indicating that rasterization of the print job is complete, and that a complete rasterized version of the print job is stored at rip spool 114. In this instance, print controller 104 rasterizes the print job once, and stores the complete rasterized version of the print job at rip spool 114. Processor 106 may then send the complete rasterized version for the print job multiple times from rip spool 114 to print engine 118, once for each copy of the print job.

During printing of a multiple copy print job, some of the raster data for the print job stored on rip spool 114 is de-spooled and sent to print engine 118, and some of the raster data for the print job is rasterized “on-the-fly” and is sent to print engine 118, bypassing the storage of this raster data rip spool 114. In some cases, storage space on rip spool 114 may change during the printing of the multiple copies of the print job. For instance, raster data for a previously printed job may be deleted from rip spool 114 during the printing process for a subsequent multiple copy print job. In this case, processor 106 is able to detect that more storage space has become available at rip spool 114 while printing the multiple copies of the print job. When more storage space becomes available at rip spool 114, then rasterizer 108 is able to store a larger portion of the raster data for the print job at rip spool 114, which reduces the amount of raster data that is generated “on-the-fly” using print data 120 stored in buffer 112. This type of dynamic adjustment of raster data stored at rip spool 114 allows rip spool 114 to be used more efficiently, while subsequently reducing the computational burden that arises when raster data is generated “on-the-fly” for each of the multiple copies of the print job.

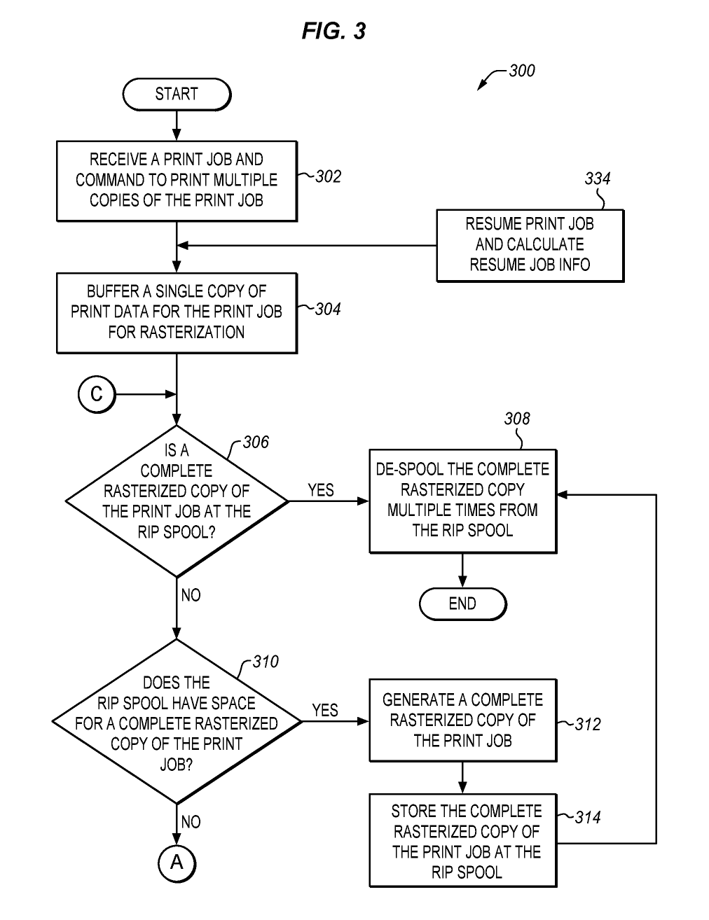

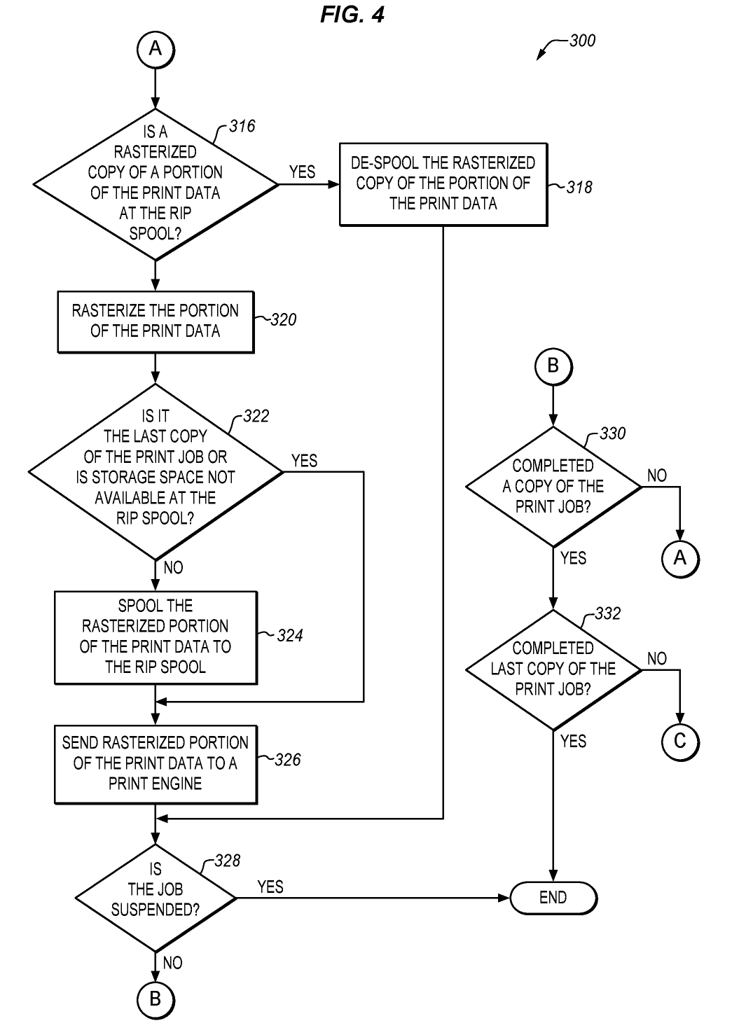

FIGS. 3-4 are flow charts for another method 300 of dynamically storing raster data at a rip spool during a multiple copy print job in another exemplary embodiment. Method 300 will be described with respect to printing system 102, although one of ordinary skill in the art will recognize that method 300 may be performed by other systems, not shown.

For this embodiment, consider that printing system 102 is operational and receives a print job and a command to print multiple copies of the print job (see step 302 of FIG. 3). Print controller buffers a single copy of print data 120 in buffer 112 for the print job (see step 304). Processor 106 analyzes the raster data stored at rip spool 114 to determine if a complete rasterized copy of the print job is stored at spool 114 (see step 306). If a complete rasterized copy of the print job is stored at rip spool 114, then processor 106 de-spools the complete rasterized copy of the print job multiple times from rip spool 114 to print engine 118, once for each copy of the multiple copies of the print job (see step 308).

If a complete rasterized copy of the print job is not stored at rip spool 114, then processor 106 determines if rip spool 114 has space available for a complete rasterized copy of the print job (see step 310). If space is available, then rasterizer 108 generates a complete rasterized copy of the print job (see step 312), and processor 106 stores the complete rasterized copy of the print job at rip spool 314. Processor 106 may then de-spool the complete rasterized copy multiple times from rip spool 114 to print engine 118, once for each copy of the multiple copies of the print job (see step 308).

If rip spool 114 does not have space for a complete rasterized copy of the print job, then processor 106 determines if a rasterized copy of a portion of print data 120 for the print job is at rip spool 114 (see step 316). If a rasterized copy of the portion of print data 120 for the print job is at rip spool 114, then processor 106 de-spools the rasterized copy of the portion of print data 120 for the print job to print engine 118 (see step 318). Processor 106 then checks to determine if the print job has been suspended (see step 328). If the print job has been suspended, then method 300 ends. However, if the print job has not been suspended, then processor 106 determines if a copy of the print job has been completed (see step 330). If a copy of the print job has not been completed, then the processing of method 300 returns to step 316 and another portion of print data 120 is processed. If a copy of the print job has been completed, the processor 106 determines if a last copy of the print job has been completed (see step 332). If the last copy has not been completed, then the processing of method 300 returns to step 306. However, if the last copy has been competed, then method 300 ends.

Returning to step 316, if processor 106 determines that a rasterized copy of the portion of print data 120 is not at rip spool 114, then rasterizer 108 rasterizes the portion of print data 120 (see step 320). Processor 106 then determines if rip spool 114 has storage space available to store the rasterized portion of print data 120, and if it is the last copy of the print job (see step 322). If it is the last copy of the print job or storage space is not available at rip spool 114, then processing of method 300 returns to step 326 to send the rasterized portion of the print data to print engine 118. Processor 106 then determine if the print job is suspended. If the print job is suspended, then method 300 ends. However, if the print job is not suspended, the steps 330-332 of method 300 are performed, which have been previously described.

If storage space at rip spool 114 is available to store the rasterized portion of print data 120, and it is not the last copy of the print job, then rasterizer 108 spools the rasterized portion of print data 120 to rip spool 114 (see step 324). Processor 106 sends the rasterized portion of the print data to print engine 118 (see step 326). Processor 106 then determines of the print job is suspended (see step 328). If the print job is suspended, then method 300 ends. However, if the print job is not suspended, then steps 330-332 of method 300 are performed, which have been previously described.

In some cases, a print job is suspended during printing of the copies of the multiple copy print job. In this case, method 300 ends as previously described. If raster data for the print job is not deleted from rip spool 114, then a subsequent resumption of the print job may restart method 300 and access raster data at rip spool 114 that was stored before the print job was suspended. If a multiple copy print job is resumed (e.g., by receiving a resume command), then resume job information (e.g., starting page, remaining number of copies, etc.) for the print job is calculated by processor 106 (see step 334), and processor 106 buffers a single copy of print data 120 for the print job in buffer 112 for rasterization.

As previously described, method 300 is an iterative process whereby portions of print data 120 are processed by print controller 104. During processing of a particular portion of print data 120, print controller 104 determines if raster data for the portion is at rip spool 114. If raster data is at rip spool 114 for that portion of print data 120 being processed, then print controller 104 is able to de-spool that portion to print engine 118 during printing of each of the multiple copies. If the raster data for the portion is not at rip spool 114, then print controller 104 rasterizes the portion of print data 120 “on-the-fly”. If space is available at rip spool 114 for this raster data, then it is stored at rip spool 114 and can be de-spooled multiple times to print engine 118 during each copy of the multiple copy process. However, if space is not available at rip spool 114 for this raster data, then it is provided instead to print engine 118 during each copy of the multiple copy process.

Utilizing method 300, print controller 104 is able to dynamically store raster data for a print job at rip spool 114 as storage space becomes available during printing of the multiple copies of the print job, thereby reducing the amount of raster data for the print job that is generated “on-the-fly” for each copy of the print job. Reducing the amount of raster data that is generated “on-the-fly” also reduces the computational burden on print controller 104, thereby allowing print controller 104 to perform other tasks that may be executing at printing system 102.

### Example

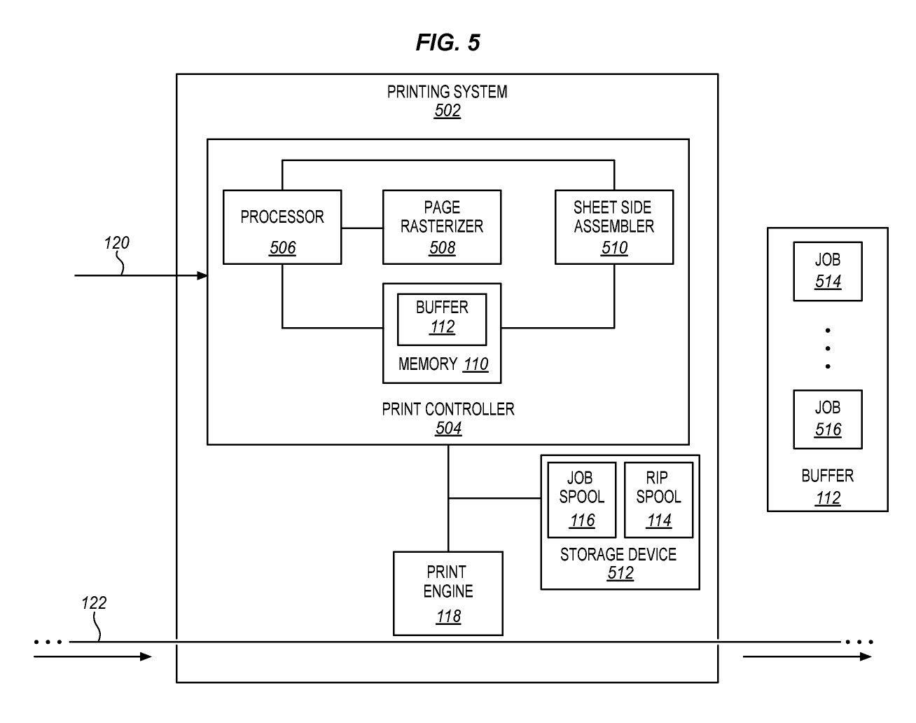

FIG. 5 is a block diagram of another printing system 502 in another exemplary embodiment. Similar to FIG. 1, printing system 502 applies a colorant to media 122. Printing system 502 includes a print controller 504, print engine 118, and a storage device 512. Stored on storage device 512 is a first partition that stores rip spool 114 and a second partition that stores job spool 116. In print controller 504, a page rasterizer 508 “rips” logical pages of a print job into bitmap images. Page rasterizer 508 will store the bitmap images at rip spool 114 if rip spool 114 is available to store raster data for the print job, and will send the bitmap images to print engine 118 or a sheet side assembler 510 if rip spool 114 is not available to store raster data for the print job. In n-up printing, a sheet side image may be assembled from multiple ripped pages. Sheet side assembler 510 builds sheet side images from the bitmap images of the logical pages. Sheet side assembler 510 may also attempt to store (i.e., spool) sheet side images to rip spool 114. In the example, consider that a number of print jobs are spooled to job spool 116, such as print job j, j+1, etc. In order to print job j, the print job is de-spooled and buffered for rasterization. Typically, print job j+1 is de-spooled and buffered subsequent to print job j. However, processor 506 determines that print job j is intended to print multiple times (i.e., print job j is a multiple copy job). Thus, processor 506 buffers up one copy of print job j in buffer 112. The one copy of print job j is shown as print job 514 in buffer 112. Print job j+1 is shown as print job 516. In the example, print jobs are rasterized based on an order in buffer 112. Therefore, print job 514 is rasterized before print job 516. During a rasterization process, page rasterizer 508 stores rasterized logical pages of a print job at rip spool 114. When n-up printing for the print job indicates multiple logical pages per side, sheet side assembler 510 may assemble sheet side images from the logical pages and store the sheet side images at rip spool 114. For example, page rasterizer 508 may provide bitmap images of the logical pages of a print job to sheet side assembler 510 (either using raster data in buffer 112 or using raster data at rip spool 114) for use by sheet side assembler 510 in assembling sheet side images. Regardless, in some cases rip spool 114 may not be able to store a complete rasterized version of print job 514. Typically, this causes print job 514 to be aborted, as other print jobs (e.g., print job 516) are already pipelined or buffered for rasterization. In other words, it may be too late to go back and de-spool multiple times into buffer 112, print job 514 for the rasterization process. To address this problem, page rasterizer 508 generates a portion of raster data for print job 514 based on an amount of storage space available at rip spool 114, and stores the portion of the raster data for print job 514 at rip spool 114. Processor 506 will send the portion of the raster data for print job 514 multiple times from rip spool 114 to print engine 118 (e.g., for 1-up printing) or to sheet side assembler 510 (e.g., for n-up printing, when n>1), once for each copy of print job 514. For another portion of raster data that is not stored at rip spool 114 for print job 514, page rasterizer 508 rasterizer “on-the-fly” the other portion of print job 514 stored in buffer 112 multiple times, once for each copy of print job 514. Page rasterizer 508 may then send the other portion of the raster data for print job 514 to print engine 118 (e.g., for 1-up printing) or to sheet side assembler 510 (e.g., for n-up printing, when n>1), once for each copy of print job 514. If at some point during the multiple copy process for print job 514 that additional storage becomes available at rip spool 114 for storing raster data for other portions of print job 514, then additional raster data for other portions of print job 514 is stored at rip spool 114, which reduces the amount of raster data that is generated “on-the-fly” by page rasterizer 508 and reduces the computational overhead associated with this type of process.

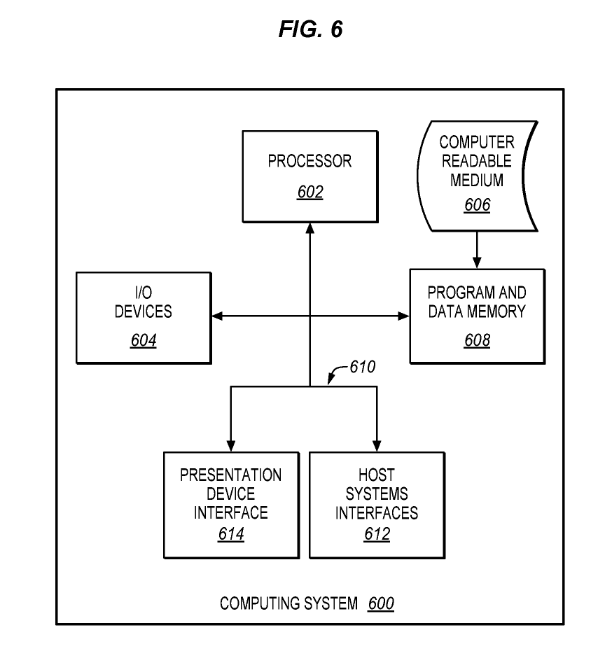

The invention can take the form of an entirely hardware embodiment, an entirely software embodiment or an embodiment containing both hardware and software elements. In one embodiment, the invention is implemented in software, which includes but is not limited to firmware, resident software, microcode, etc. FIG. 6 illustrates a computing system 600 in which a computer readable medium may provide instructions for performing the methods of FIGS. 2-4 in an exemplary embodiment.

Furthermore, the invention can take the form of a computer program product accessible from a computer-usable or computer-readable medium 606 providing program code for use by or in connection with a computer or any instruction execution system. For the purposes of this description, a computer-usable or computer-readable medium 606 can be any apparatus that can contain, store, communicate, or transport the program for use by or in connection with the instruction execution system, apparatus, or device.

Computer-readable medium 606 can be an electronic, magnetic, optical, electromagnetic, infrared, or semiconductor system (or apparatus or device) or a propagation medium. Examples of a computer-readable medium 606 include a semiconductor or solid state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include one or more processors 602 coupled directly or indirectly to memory 608 through a system bus 610. The memory 608 can include local memory employed during actual execution of the program code, bulk storage, and cache memories which provide temporary storage of at least some program code in order to reduce the number of times code is retrieved from bulk storage during execution.

Input/output or I/O devices 604 (including but not limited to keyboards, displays, pointing devices, etc.) can be coupled to the system either directly or through intervening I/O controllers.

Network adapters may also be coupled to the system to enable the data processing system to become coupled to other data processing systems, such a through host systems interfaces 612, or remote printers or storage devices through intervening private or public networks. Modems, cable modem and Ethernet cards are just a few of the currently available types of network adapters. A presentation device interface (I/F) 614 may be used to present information to a user.

Although specific embodiments were described herein, the scope of the invention is not limited to those specific embodiments. The scope of the invention is defined by the following claims and any equivalents thereof.

1. An apparatus comprising:
a print controller configured to receive a print job and a command to print multiple copies of the print job, and to store print data for the print job in a buffer;
responsive to initiating a printing of one copy of the multiple copies of the print job, the print controller is further configured to:
rasterize a first portion of the print data stored in the buffer to generate a first rasterized portion; and
store the first rasterized portion at a rip spool; and
responsive to initiating a printing of a subsequent copy of the multiple copies of the print job, the print controller is further configured to:
send the first rasterized portion from the rip spool to a print engine;
rasterize a second portion of the print data stored in the buffer that is not stored at the rip spool to generate a second rasterized portion;
determine if an amount of storage space available at the rip spool is sufficient to store the second rasterized portion; and
store the second rasterized portion at the rip spool responsive to determining that the amount of storage space is sufficient.

2. The apparatus of claim 1, wherein responsive to initiating the printing of the one copy, the print controller is further configured to:
determine whether the first rasterized portion remains in the buffer after rasterizing the first portion of the print data, and to:
send the first rasterized portion from the rip spool to the print engine responsive to determining that the first rasterized portion does not remain in the buffer; and
send the first rasterized portion from the buffer to the print engine responsive to determining that the first rasterized portion does remain in the buffer;
rasterize the second portion of the print data stored in the buffer that is not stored at the rip spool to generate the second rasterized portion; and
send the second rasterized portion to the print engine and bypass storage of the second rasterized portion at the rip spool.

3. The apparatus of claim 1, wherein responsive to initiating the printing of the subsequent copy, the print controller is further configured to:
determine that a complete rasterized copy of the print job is stored at the rip spool, and to send the complete rasterized copy from the rip spool to the print engine multiple times to print the multiple copies of the print job.

4. The apparatus of claim 1, wherein:
the print controller is configured to receive a command to suspend printing of the print job, and to suspend printing the multiple copies of the print job; and
the print controller is further configured to receive a command to resume printing of the print job, to identify raster data stored at the rip spool for the print job prior to suspension of the print job, and to resume printing of the print job based on the command to resume and the raster data stored at the rip spool for the print job prior to the suspension of the print job.

5. The apparatus of claim 1, wherein:
the print controller is further configured to store a single copy of the print data for the print job in the buffer for rasterization.

6. The apparatus of claim 1, wherein:
the print data is in a page description language; and
the rip spool is configured to store bitmap images of logical pages of the print data.

7. A method comprising:
receiving a print job and a command to print multiple copies of the print job;
storing print data for the print job in a buffer;
responsive to initiating a printing of one copy of the multiple copies of the print job:
rasterizing a first portion of the print data stored in the buffer to generate a first rasterized portion; and
storing the first rasterized portion at a rip spool; and
responsive to initiating a printing of a subsequent copy of the multiple copies of the print job:
sending the first rasterized portion from the rip spool to a print engine;
rasterizing a second portion of the print data stored in the buffer that is not stored at the rip spool to generate a second rasterized portion;
determining if an amount of storage space available at the rip spool is sufficient to store the second rasterized portion; and
storing the second rasterized portion at the rip spool responsive to determining that the amount of storage space available is sufficient.

8. The method of claim 7, wherein responsive to initiating the printing of the one copy, the method further comprises:
determining whether the first rasterized portion remains in the buffer after rasterizing the first portion of the print data, and to:
sending the first rasterized portion from the rip spool to the print engine responsive to determining that the first rasterized portion does not remain in the buffer; and
sending the first rasterized portion from the buffer to the print engine responsive to determining that the first rasterized portion does remain in the buffer;
rasterizing the second portion of the print data stored in the buffer that is not stored at the rip spool to generate the second rasterized portion; and
sending the second rasterized portion to the print engine and bypassing storage of the second rasterized portion at the rip spool.

9. The method of claim 7, wherein responsive to initiating the printing of the subsequent copy, the method further comprises:
determining that a complete rasterized copy of the print job is stored at the rip spool; and
sending the complete rasterized copy from the rip spool to the print engine multiple times to print the multiple copies of the print job.

10. The method of claim 7, wherein the method further comprises:
receiving a command to suspend printing of the print job, and to suspend printing the multiple copies of the print job;
receiving a command to resume printing of the print job;
identifying raster data stored at the rip spool for the print job prior to suspension of the print job; and
resuming printing of the print job based on the command to resume and the raster data stored at the rip spool for the print job prior to the suspension of the print job.

11. The method of claim 7, wherein storing the print data further comprises:
storing a single copy of the print data for the print job in the buffer for rasterization.

12. The method of claim 7, wherein:
the print data is in a page description language; and
the rip spool stores bitmap images of logical pages of the print data.

13. A non-transitory computer-readable medium comprising programmed instructions which, when executed by a processor of a print controller, direct the processor to:
receive a print job and a command to print multiple copies of the print job;
store print data for the print job in a buffer;
responsive to initiating a printing of one copy of the multiple copies of the print job:
rasterize a first portion of the print data stored in the buffer to generate a first rasterized portion; and
store the first rasterized portion at a rip spool; and
responsive to initiating a printing of a subsequent copy of the multiple copies of the print job:
send the first rasterized portion from the rip spool to a print engine;
rasterize a second portion of the print data stored in the buffer that is not stored at the rip spool to generate a second rasterized portion;
determine if an amount of storage space available at the rip spool is sufficient to store the second rasterized portion; and
store the second rasterized portion at the rip spool responsive to determining that the amount of storage space available is sufficient.

14. The non-transitory computer-readable medium of claim 13, wherein responsive to initiating the printing of the one copy, the programmed instructions further direct the processor to:
determine whether the first rasterized portion remains in the buffer after rasterizing the first portion of the print data, and to:
send the first rasterized portion from the rip spool to the print engine responsive to determining that the first rasterized portion does not remain in the buffer; and
send the first rasterized portion from the buffer to the print engine responsive to determining that the first rasterized portion does remain in the buffer;
rasterize the second portion of the print data stored in the buffer that is not stored at the rip spool to generate the second rasterized portion; and
send the second rasterized portion to the print engine and bypass storage of the second rasterized portion at the rip spool.

15. The non-transitory computer-readable medium of claim 13, wherein responsive to initiating a printing of the subsequent copy, the programmed instructions further direct the processor to:
determine that a complete rasterized copy of the print job is stored at the rip spool; and
send the complete rasterized copy from the rip spool to the print engine multiple times to print the multiple copies of the print job.

16. The non-transitory computer-readable medium of claim 13, wherein the programmed instructions further direct the processor to:
receive a command to suspend printing of the print job;
suspend printing the multiple copies of the print job;
receive a command to resume printing of the print job;
identify raster data stored at the rip spool for the print job prior to suspension of the print job; and
resume printing of the print job based on the command to resume and the raster data stored at the rip spool for the print job prior to the suspension of the print job.

17. The non-transitory computer-readable medium of claim 13, wherein the programmed instructions further direct the processor to:
store a single copy of the print data for the print job in the buffer for rasterization.

18. The non-transitory computer-readable medium of claim 13, wherein:
the print data is in a page description language; and
the rip spool stores bitmap images of logical pages of the print data.
